(19) United States
(12) Patent Application Publication
(10) Pub. No.: US 2021/0289604 A1
(43) Pub. Date: Sep. 16, 2021

(54) ILLUMINATION DEVICE

(71) Applicant: OMRON Corporation, Kyoto-shi, KYOTO (JP)

(72) Inventor: Tanichi ANDO, Komaki-shi (JP)

(73) Assignee: OMRON Corporation, Kyoto-shi, KYOTO (JP)

(21) Appl. No.: 16/334,519

(22) PCT Filed: Mar. 14, 2017
(86) PCT No.: PCT/JP2017/010209

§ 371 Date: Mar. 19, 2019

(30) Foreign Application Priority Data
Nov. 11, 2016 (JP) 2016-220432

(51) Int. Cl. H05B 47/155; G05B 13/02; G06K 9/20; G06K 9/62; G06N 3/04; G06N 3/08

(52) U.S. Cl. CPC H05B 47/155; G05B 13/027; G06K 9/2036; B60Q 1/12; G06K 9/2027; G06N 3/04; G06N 3/08; G06K 9/6256

(57) ABSTRACT

An illumination device includes at least one light source configured to perform illumination with a plurality of illumination patterns, a detection unit for detecting state information on the state of an illumination target that is to be illuminated by the light source, an arithmetic unit configured to calculate, using a neural network, illumination pattern information for generating an illumination pattern appropriate for the illumination target from the state information, and an illumination control unit configured to control the light source in order to perform illumination with an illumination pattern based on the illumination pattern information.

### TECHNICAL FIELD

The present invention relates to an illumination device, an illumination method, and an illumination program.

### BACKGROUND ART

Conventionally, in production lines, in order to inspect articles, which are manufactured products, e.g. labels on articles are read (see, for example, PTL 1) by capturing images of the articles using a camera and performing image processing on the captured images. In this case, in order to capture images appropriate for reading the labels on the articles, the articles are illuminated appropriately for image capturing.

### CITATION LIST

### Patent Literature

### [PTL 1]

### JP 2005-208054A

### SUMMARY OF INVENTION

### Technical Problem

However, in the above-described inspection, there is a risk that if an article that is conveyed is displaced from its proper position, it is no longer possible to correctly illuminate that article, and so an image appropriate for recognition of the label cannot be captured. This problem is not limited to production lines such as that described above, but may arise in all illumination devices that illuminate an illumination target with respect to which the environment and the state may change.

The present invention was made to address the above-described problem, and it is an object thereof to provide an illumination device that can appropriately illuminate an illumination target even when the state of the illumination target changes.

### Solution to Problem

An illumination device according to the present invention includes at least one light source configured to perform illumination with a plurality of illumination patterns; a detection unit for detecting state information on the state of an illumination target that is to be illuminated by the light source; an arithmetic unit configured to calculate, using a neural network, illumination pattern information for generating an illumination pattern appropriate for the illumination target from the state information; and an illumination control unit configured to control the light source in order to perform illumination with an illumination pattern based on the illumination pattern information.

With this configuration, it is possible to determine an optimal illumination pattern for the state of the illumination target by using the neural network. Accordingly, it is possible to optimally illuminate the illumination target even when the state of the illumination target changes. In particular, the use of the neural network makes it possible to calculate an optimal illumination pattern even when the illumination target changes in a complex manner.

The above-described illumination device can further include a learning unit for training the neural network. Also, the learning unit can train the neural network using learning data, the learning data containing the state information detected by the detection unit and illumination pattern data corresponding to the state information.

With this configuration, the illumination device includes the learning unit, and thus learning of the neural network can be performed as appropriate. Therefore, even when the illumination target further changes, the illumination device itself performs learning, and thus, the illumination pattern can be further optimized using the neural network. Consequently, it is possible to perform appropriate illumination adapted for the further change in the state of the illumination target.

In the above-described illumination device, the arithmetic unit can include the neural network for each of a plurality of illumination targets or for each of a plurality of types of light sources.

In the above-described illumination device, the illumination pattern can be defined by at least one of brightness, color, direction, position, and whether or not light is emitted from the one or more light sources.

The above-described illumination device can further include a communication unit for receiving learning data for training the neural network over a network. Thus, even when the illumination device itself does not have a learning function, it is possible to acquire learning data from the outside and allow the neural network to learn. For example, in the case where extensive learning data is required, the load on the illumination device is large if the illumination device itself learns, and therefore, it is preferable to prepare learning data outside the illumination device.

In the above-described illumination device, the detection unit can be configured to acquire an image of the illumination target and calculate the state information from the image. Thus, a complex change in the illumination target can also be calculated as state information, and therefore, it is possible to generate an optimal illumination pattern even when the illumination target changes in a complex manner.

An illumination method according to the present invention includes the steps of detecting state information on the state of an illumination target that is to be illuminated by a light source; calculating, using a neural network, illumination pattern information for generating an illumination pattern of the light source appropriate for the illumination target from the state information; and controlling the illumination pattern of the light source based on the illumination pattern information.

The above-described illumination method can further include the steps of acquiring learning data, the learning data containing the state information and illumination pattern data for performing optimal illumination corresponding to the state information; and training the neural network using the learning data.

An illumination program according to the present invention causes a computer to execute the steps of detecting state information on the state of an illumination target that is to be illuminated by a light source; calculating, using a neural network, illumination pattern information for generating an illumination pattern of the light source appropriate for the illumination target from the state information; and controlling the illumination pattern of the light source based on the illumination pattern information.

The above-described illumination program can further cause the computer to execute the steps of acquiring learning data, the learning data containing the state information and illumination pattern data for performing optimal illumination corresponding to the state information; and training the neural network using the learning data.

### Advantageous Effects of Invention

According to the present invention, it is possible to appropriately illuminate an illumination target even when the state of the illumination target changes.

### BRIEF DESCRIPTION OF DRAWINGS

FIG. 1 is a schematic diagram showing an embodiment of the present invention in the case where an illumination device according to the present invention is applied to an article inspection system.

FIG. 2 is a block diagram of the illumination device.

FIG. 3 is a block diagram showing a functional configuration of the illumination device.

FIG. 4 is a plan view showing articles that are conveyed.

FIG. 5 schematically shows illumination patterns.

FIG. 6 is a flowchart illustrating learning of a neural network.

FIG. 7 is a flowchart illustrating a procedure for calculating an illumination pattern using the neural network.

FIG. 8 is a schematic diagram showing a case in which the illumination device of the present invention is applied to illumination in a room.

FIG. 9 shows diagrams for explaining a case where the illumination device of the present invention is applied to a headlight of an automobile.

FIG. 10 is a block diagram showing a functional configuration of another example of the illumination device shown in FIG. 3.

### DESCRIPTION OF EMBODIMENTS

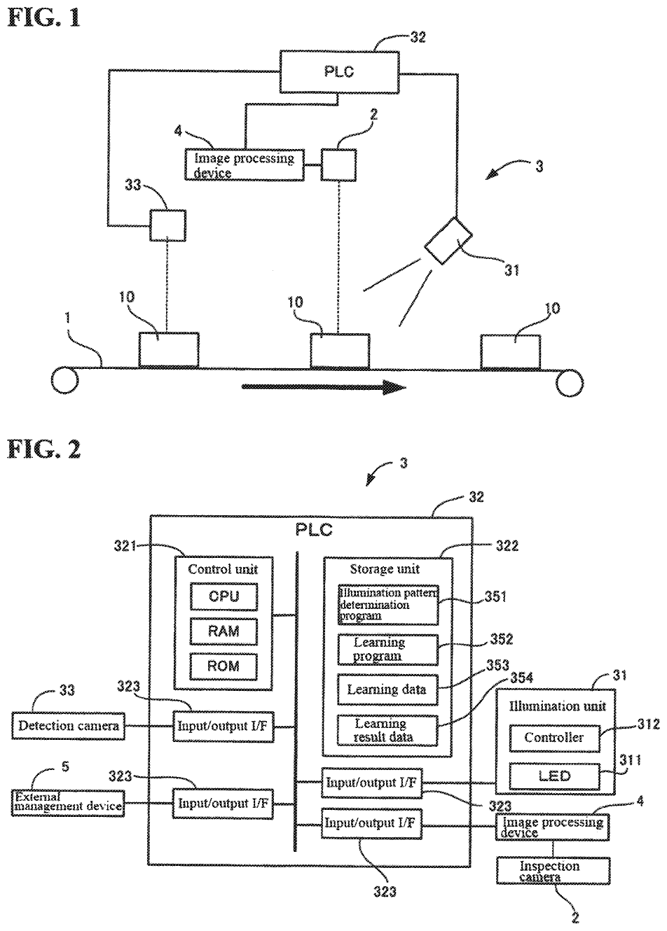

Hereinafter, an embodiment of the present invention in the case where an illumination device according to the present invention is applied to an article inspection system will be described with reference to the drawings. FIG. 1 is a schematic diagram of the inspection system, and FIG. 2 is a block diagram of the illumination device.

Outputs of an NN (neural network) are connected to an element for controlling the illuminance and the like of illumination LEDs.

An illumination control device according to a main aspect of the present invention includes an evaluation device for outputting the difference between a target value and a current value. The evaluation device also may be contained in a housing separate from the illumination device.

When a request including a target value (for example, a request to make the brightness on a table surface serving as an illumination target uniform (within a tolerance of 3%)) is sent to the control device from a user, the NN performs learning so as to make the output of the evaluation device satisfy this condition, meanwhile producing an output and controlling the illumination LEDs. When a change (a change in shape, introduction of another object, or the like) occurs in the illumination target, the state deviates from the target value, and the evaluation device thus increases the output again. The NN performs learning so as to satisfy the condition again and controls the illumination LEDs. At the time when the output becomes lower than a threshold value, the NN completes learning and maintains the illumination state.

It should be noted that the target value and the current value are not limited to numerical values such as illuminance, and may also be image information. When learning is completed, and the illumination state reaches the target value, the illumination control device may notify the user of the attainment of the goal. Furthermore, the illumination control device may also be configured to accept an additional request, such as a request to partially change brightness or a request to partially change color.

1. Schematic Configuration of Inspection System

As shown in FIG. 1, the inspection system according to the present embodiment includes an inspection camera 2 that captures an image of properties of an article (illumination target) 10 conveyed by a conveyor 1 and an illumination device 3 for illuminating the range of the field of view of the inspection camera 2 and the surroundings of that range.

The inspection camera 2 captures an image of a label on the article, externally visible properties of the article, and the like. Moreover, an image processing device 4 is connected to the inspection camera 2, and performs image processing on the captured image, thereby reading the label on the article 10 and detecting any defects of the article. Here, by way of example, in order to read a label on an upper surface of the article 10, the inspection camera 2 is disposed so as to capture an image of the article 10 on the conveyor 1 from above.

Moreover, as shown in FIG. 2, the illumination device 3 includes an illumination unit 31 that includes a plurality of LEDs (light sources) 311, a PLC (programmable logic controller) 32 that determines an illumination pattern of the LEDs 311, and a detection camera 33 for capturing an image of the type, externally visible properties, position, and the like of the article that is conveyed in order to determine the illumination pattern of the LEDs 311. Each of these constituent elements will be described below.

2. Illumination Unit

The illumination unit 31 includes the plurality of LEDs 311 and a known controller (illumination control unit) 312 for controlling illumination of these LEDs 311. Here, by way of example, the plurality of LEDs 311 are arranged in such a manner as to form a rectangular shape as a whole, and these LEDs 311 are arranged so as to irradiate the article 10 with light from a position downstream of the article 10 with respect to the conveyance direction and obliquely above the article 10. The controller 312 controls the brightness and color of each LED 311 and also controls which of the plurality of LEDs 311 to turn on. That is to say, the controller 312 controls illumination such that the plurality of LEDs 311 illuminate with a predetermined illumination pattern.

3. PLC

The PLC 32 mainly determines an optimal illumination pattern of the LEDs 311 for capturing an image of the article 10 that is conveyed using the inspection camera 2. Also, the PLC 32 sends a control signal corresponding to the determined illumination pattern to the above-described controller 312. Specifically, the PLC 32 has a hardware configuration such as that shown in FIG. 2.

As shown in FIG. 2, the PLC 32 is a computer in which a control unit 321 including a CPU (Central Processing Unit), a RAM (Random Access Memory), a ROM (Read Only Memory) or the like, a storage unit 322 that stores a program or the like to be executed by the control unit 321, and input/output interfaces 323 for performing data communication with an external management device 5 or the like are electrically connected to one another. It should be noted that in FIG. 2, the input/output interfaces are each indicated as “input/output I/F”.

The PLC 32 according to the present embodiment includes four input/output interfaces 323, and the above-described image processing device 4, external management device 5, illumination unit 31, and detection camera 33 are connected to the respective input/output interfaces 323. Thus, the PLC 32 can control the illumination unit 31 and the detection camera 33 and acquire information related to image analysis from the image processing device 4 via the respective input/output interfaces 323. Also, the PLC 32 can acquire various kinds of information from the external management device 5.

The external management device 5 is a device for performing overall management of the inspection system including management of illumination, and sends, for example, basic operation commands, such as turning on/off of illumination, as well as information on the article 10 that is conveyed to the PLC 32.

The detection camera 33 is not limited to specific types, and any type of camera can be used as long as it can capture an image of the externally visible properties, position on the conveyor 1, and the like of the article 10 that is conveyed.

Programs for causing the control unit 321 to control the various constituent elements and also execute processing for determining an optimal illumination pattern are stored in the storage unit 322. In the present embodiment, mainly an illumination pattern determination program 351 and a learning program 352 are stored. Specific processing will be described later. Learning data 353 is data for allowing a neural network, which will be described later, to learn. The learning data 353 may also contain information that is called teacher data. Learning result data 354 is data on the neural network after learning, and contains connection weights and the like. Alternatively, in the case where learning has not been performed yet, the learning result data 354 contains data on default connection weights and other data. The programs 351 and 352 and the data 353 and 354 related to learning may also be stored in a storage medium. The storage medium is a medium in which information of the programs and the like are accumulated by using an electric, magnetic, optical, mechanical, or chemical effect so that computers and other devices, machines, and the like can read information of the programs and the like stored in the storage medium.

It should be noted that with regard to a specific hardware configuration of the PLC 32, constituent elements can be omitted, substituted, and added as appropriate depending on the embodiment. For example, the control unit 321 may also include a plurality of processors. Moreover, it is also possible that the PLC 32 includes further input/output interfaces and is connected to and controls other constituent components of the inspection system. Moreover, the PLC 32 may also include an input device through which a worker performs an input operation. The input device may be constituted by, for example, a keyboard, a touch panel, and the like.

4. Determination of Illumination Pattern

4-1. Illumination Pattern

Next, a method for determining an illumination pattern will be described. In capturing an image of the article 10 using the inspection camera 2, various illumination methods can be adopted. Examples of the illumination methods include a specular reflection type in which light reflected from the article 10 by specular reflection is captured by the inspection camera 2, a diffuse reflection type in which light reflected from the article 10 by specular reflection is let through and overall uniform light is captured by the inspection camera, and a transmission type in which the article 10 is illuminated from the background thereof and a silhouette is captured using the transmitted light.

Moreover, depending on the portion of the article 10 an image of which is to be captured, the angle of incidence of illumination and the position of illumination are also important, and concomitantly, it is necessary to also determine which of the plurality of LEDs to turn on. Furthermore, depending on the type and the background of the article 10, it is necessary to adjust the intensity (brightness) and the color (wavelength) of illumination in order to create a contrast.

With respect to the above-described illumination pattern, when identical articles 10 are conveyed, the same illumination pattern is used; however, if any of these articles 10 is displaced from its proper position on the conveyor 1, it is no longer possible to appropriately illuminate that article 10 even though it is identical to the other articles 10, and consequently, there is a possibility that a desired image cannot be obtained on the inspection camera 2. To address this issue, the present embodiment adopts a method for determining an illumination pattern by using a neural network as described below. Here, by way of example, a form of control will be described in which, when a label on a surface of an article 10 is to be read by the inspection camera 2, illumination adjustment appropriate for the position and the slant of that article on the conveyor 1 is performed.

4-2. Functional Configuration of PLC

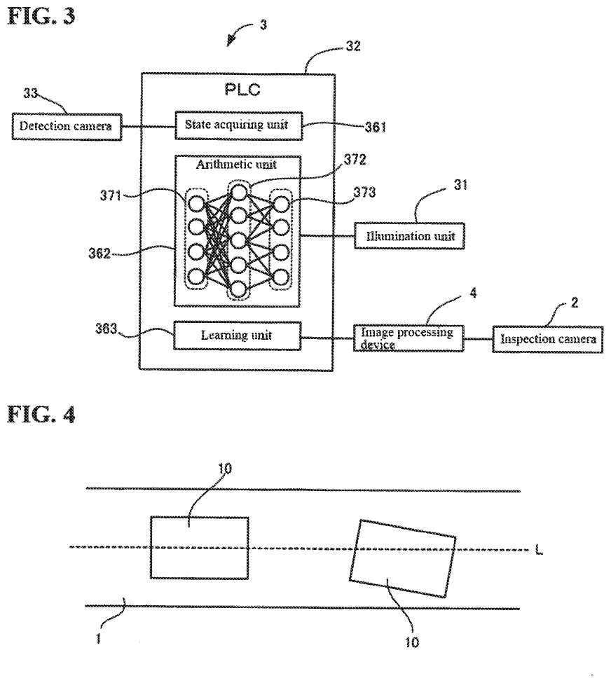

Hereinafter, an example of a functional configuration of the PLC 32 for determining an illumination pattern will be described. FIG. 3 schematically shows an example of the functional configuration of the PLC 32 according to the present embodiment. The control unit 321 of the PLC 32 loads the programs stored in the storage unit 322 into the RAM. Then, the control unit 321 causes the CPU to interpret and execute the programs loaded into the RAM, thereby controlling the various constituent elements. Thus, as shown in FIG. 3, the PLC 32 according to the present embodiment functions as a computer that includes a state acquiring unit 361, an arithmetic unit 362, and a learning unit 363. It should be noted that a configuration may also be adopted in which only the learning unit 363 is executed independently.

The state acquiring unit 361 analyzes an image captured by the detection camera 33 and acquires the state of displacement of the article 10 from its proper position on the conveyor 1. For example, the state acquiring unit 361 analyzes how a surface of the article 10 on which the label to be read by the inspection camera 2 is applied is displaced from its proper position. Specifically, for example, as shown in FIG. 4, the state acquiring unit 361 analyzes the extent to which the article 10 is shifted from a center line L of the conveyor 1 with respect to the conveyance direction, the extent to which the article 10 is slanted from the center line L, and so on from the image captured by the detection camera 33, and outputs the position and the slant of the article 10. In the following description, data on the position and the slant of the article 10 will be referred to as state data (state information).

The arithmetic unit 362 includes a neural network. For example, as shown in FIG. 3, it is possible to employ a neural network having an input layer 371, an intermediate layer 372, and an output layer 373. Also, the input layer 371 and the intermediate layer 372 are interconnected with connection weights, and the intermediate layer 372 and the output layer 373 are interconnected with connection weights.

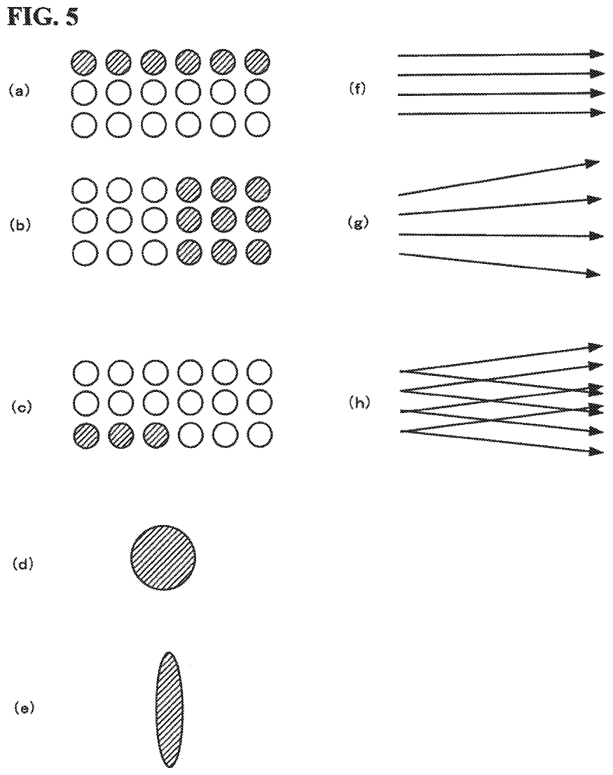

State data generated by the above-described state acquiring unit 361 is input to the input layer 371. On the other hand, whether or not to turn on the individual LEDs 311, the brightness, and the color are output from the output layer 373 as illumination pattern data (illumination pattern information). That is to say, the illumination pattern data indicates an illumination pattern that can create an appropriate contrast and the like so as to enable the inspection camera 2 to reliably read the label on the article. Examples of the illumination pattern are as follows. In the case where the plurality of LEDs 311 are arrayed, as shown in FIGS. 5(a) to 5(c), only a required portion can be turned ON (hatched portion). Alternatively, as shown in FIGS. 5(d) and 5(e), the irradiation range can be adjusted using an optical system such as a lens. Moreover, in the case where highly directional light is emitted, as shown in FIGS. 5(f) to 5(h), parallel light beams, diffused light beams, or superposed light beams can be irradiated.

Moreover, a plurality of neural networks such as that described above are prepared, and, for example, it is possible to prepare a neural network for each article type.

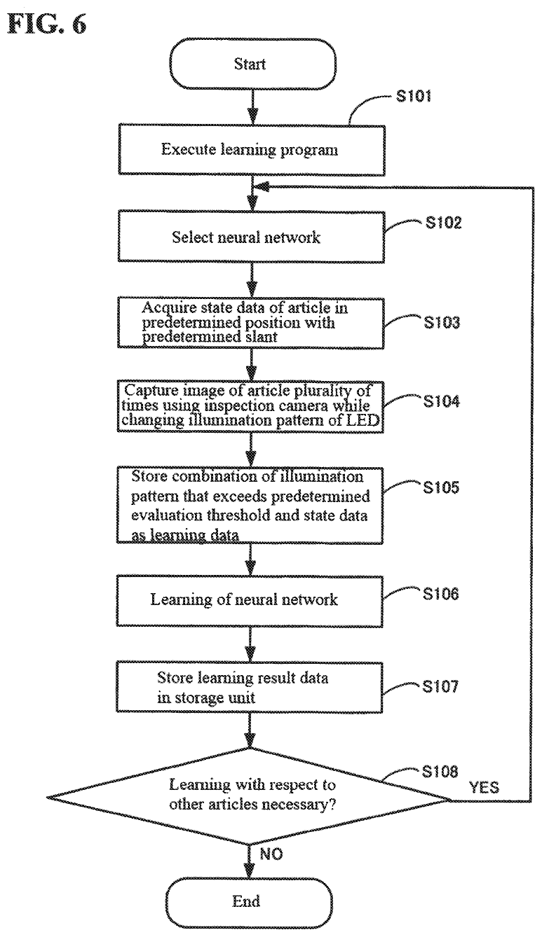

A neural network such as that described above is trained by the learning unit 363. This will be described based on a flowchart in FIG. 6. Here, a case where the article 10 is conveyed while being in a specific position with a specific slant (orientation) will be described. First, when the learning program 352 is executed (step S101), the learning unit 363 reads a neural network corresponding to the type of the article 10 from the learning result data 354 of the storage unit 322 (step S102). Next, in order to create the learning data 353, the article 10 is disposed in the above-described specific position with the above-described specific slant (orientation), and in this state, an image of the article 10 is captured by the detection camera 33, and thereby state data is acquired (step S103). Subsequently, the LEDs 311 are set to a specific illumination pattern, and in this state, an image of the label on the article 10 is captured by the inspection camera 2 (step S104). Then, while the orientation of the article 10 remains fixed, the illumination pattern of the LEDs 311 is changed a plurality of times, and images are captured by the inspection camera 2.

After that, the images captured with the respective illumination patterns are analyzed. Then, out of the plurality of illumination patterns, an illumination pattern that exceeds a predetermined evaluation threshold is selected. For example, an illumination pattern with which an appropriate contrast is created or the article 10 does not reflect other articles is selected, and the selected illumination pattern is combined with the above-described state data and stored in the storage unit 322 as the learning data 353 (step S105). Subsequently, learning (training) of the selected neural network is performed through backpropagation, for example, using the learning data 353 (step S106).

Then, if learning with respect to other articles is necessary (YES in step S108), the above-described steps S102 to S107 are repeated, whereas if learning with respect to other articles 10 is unnecessary (NO in step S108), the learning program is terminated. Neural network learning is thus finished.

Moreover, there also are cases where individual articles 10 are conveyed with different orientations. In this case, for example, after step S107, the article 10 is disposed in another possible orientation, state data is acquired, and then, image capturing by the inspection camera 2 is performed a plurality of times while changing the illumination pattern of the LEDs 311. In this manner, the above-described steps S103 to S107 are repeated for as many times as there are different orientations. Then, if the learning data 353 with respect to other articles 10 is unnecessary (NO in step S108), the learning program is terminated. Due to the above-described learning, irrespective of the orientations of the articles 10 that are conveyed, it is possible to obtain an appropriate illumination pattern on the average as a learning result. Moreover, if the learning data 353 with respect to different orientations is acquired in this manner in advance, a learning result optimized for each orientation can be obtained.

It should be noted that in the case where the articles 10 have significantly different shapes, with or without a hole, for example, different neural networks need to be used, but when the differences in shape are small, the same neural network can be used. That is to say, for articles having different shapes, state data when the articles are disposed with the same orientation or different orientations is acquired, images capturing with a plurality of illumination patterns is performed, and learning data 353 that exceeds a predetermined evaluation threshold is acquired. Then, learning of a neural network is performed using this learning data 353, and it is thus possible to set an optimal illumination pattern even when articles having different shapes are conveyed.

5. Operation of Inspection System

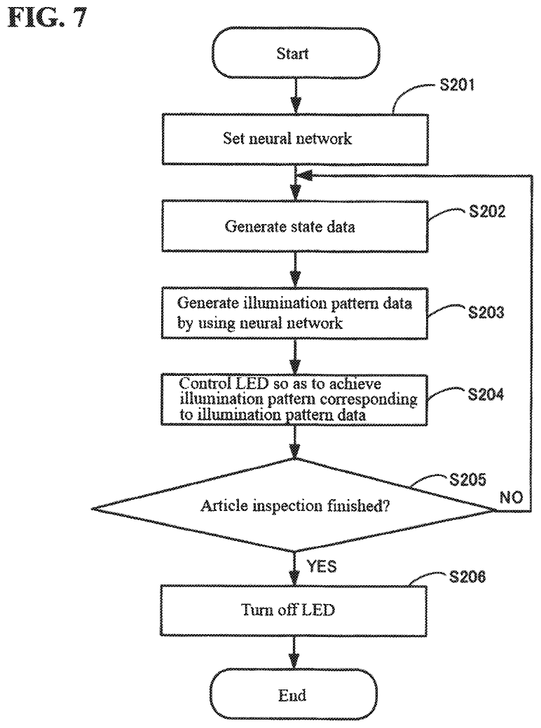

Next, the operation of the above-described inspection system will be described with reference to a flowchart in FIG. 7. First, prior to conveyance of an article, information on the type of the article 10 is input to the PLC 32 from the external management device 5, and then the arithmetic unit 362 sets a neural network corresponding to that article 10 (step S201). For example, the arithmetic unit 362 reads out desired learning result data 354 from the storage unit 322 and sets the neural network. Then, when conveyance of the article 10 is started, the detection camera 33 captures an image of the article 10, and the state acquiring unit 361 generates state data (step S202). Next, the state data is input to the neural network of the arithmetic unit 362 as input data, and illumination pattern data appropriate for the input data is output (step S203).

Subsequently, when the illumination pattern data is sent to the controller 312 of the illumination unit 31, the controller 312 controls the LEDs 311 so as to perform illumination with an illumination pattern corresponding to the illumination pattern data (step S204). In this manner, depending on the positon and the slant of the article 10 that is conveyed, optimal illumination that allows for correct reading of the label on the article 10 is performed. After that, the above-described steps S202 to S204 are repeated until the inspection is finished (NO in step S205). On the other hand, when the inspection is finished, illumination by the LEDs 311 is stopped (step S206).

6. Features

As described above, according to the present embodiment, an optimal illumination pattern that allows for reading of the label on the article 10 can be determined depending on the position and the slant of the article 10 by using a neural network. Therefore, even when the article 10 is displaced from its proper position while being conveyed, optimal illumination is performed, and thus the label on the article 10 can be reliably read.

Moreover, since the PLC 32 is provided with the learning unit 363, the illumination device 3 itself can perform learning of the neural network. Accordingly, further changes of the article, which is an illumination target, can be dealt with, and the illumination pattern can be further optimized by using the neural network.

It should be noted that, in the above-described inspection system, displacement of the article from its proper position has been described as a factor that affects the inspection result; however, this is merely an example, and the factors that affect the inspection result are not limited as long as the inspection result can be made correct by optimizing the illumination pattern. Moreover, as a result of using the neural network, even when the state (orientation and the like) of the article 10 changes in a complex manner, or even when articles 10 of different types or shapes are conveyed, an optimal illumination pattern can be calculated on an as-needed basis. Different articles 10 refer not only to articles having different shapes but also articles having different surface properties, such as color, roughness, and gloss. Moreover, although a case where the label on the article 10 is read as an inspection item to be inspected by using the inspection camera 2 has been described, this also is an example, and various inspection items, including other inspection items, for example, acquisition of the shape of the article, detection of contamination, and the like can be employed. Also, a configuration may be adopted in which a plurality of separate illumination devices are used.

7. Modifications

Although an embodiment of the present invention has been described above, the present invention is not limited to the foregoing embodiment, and various changes can be made thereto without departing from the gist thereof. Hereinafter, modifications will be described, and the following modifications can be combined as appropriate.

7-1

In the foregoing embodiment, the illumination device according to the present invention is applied to inspection of the articles 10. However, the present invention is not limited to this. The illumination device of the present invention is applicable to various illumination targets. In the following, descriptions with respect to other illumination targets are given, but the schematic configuration of the illumination device shown in FIGS. 2 and 3, learning of the neural network illustrated in FIG. 6, and the procedure for generating illumination pattern data illustrated in FIG. 7 are almost the same, and hence, like components are denoted by like reference numerals, and their descriptions may be omitted.

7-1-1

Illumination for a specific portion in a room, for example, illumination on top of a desk may be affected by various factors such as the environment in the room including, for example, light from a window, opening/closing of a door, number of persons in the room and their positions, arrangement of articles in the room, and the like. That is to say, depending on these factors, light from the light source may be reflected or transmitted, and therefore, uniform brightness over the top of the desk may not be achievable. Thus, in order to perform uniform illumination over the top of the desk, the above-described illumination device may be applied.

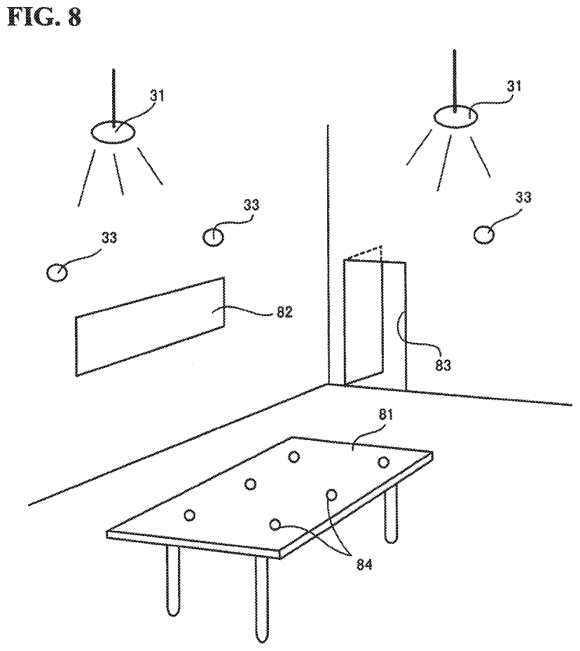

As shown in FIG. 8, in this example, a plurality of detection cameras 33 are installed on wall surfaces in a room. Illumination units 31 determine an illumination pattern so as to uniformly irradiate the top of a desk 81 in the room with light. Moreover, in order to detect light on top of the desk 81, a plurality of sensors 84 that detect light are disposed at respective portions on top of the desk 81.

In this example, state data related to various environmental factors in the room, such as opening/closing of a curtain of a window 82, opening/closing of a door 83, number of persons in the room, their positions, and positions of articles, is acquired in advance using the detection cameras 33. Then, light on top of the desk 81 when environmental factors corresponding to each piece of state data are set is detected by the sensors 84, and the illumination pattern of the illumination units 31 is optimized so that light received by the sensors 84 is made uniform. In this manner, each piece of state data and a corresponding optimal illumination pattern are stored as learning data, and the neural network of the arithmetic unit 362 is thus allowed to learn.

Then, state data of the inside of the room is acquired using the detection cameras 33, and based on this state data, illumination pattern data is calculated using the neural network after learning (i.e. after the neural network has completed the learning process). Subsequently, this illumination pattern data is sent to the illumination units 31, and the LEDs 311 of the illumination units 31 in turn irradiate the top of the desk 81 with light with an optimal illumination pattern appropriate for the environment in the room. Thus, irrespective of the environment in the room, uniform brightness over the entire top of the desk 81 is achievable. In this case, illumination pattern data may be generated continuously, for example, or can be generated at predetermined time intervals. Alternatively, illumination pattern data can be generated when instructed by a user.

It should be noted that in the example above, a case where an illumination pattern that achieves uniform brightness on top of the desk 81 is obtained has been described by way of example; however, the present invention is not limited to this, and an illumination pattern that achieves optimal brightness of a specific portion or that sets only a specific portion to be the irradiation range, for example, can also be obtained.

Moreover, in the example shown in FIG. 8, illumination in a relatively small room has been described; however, for example, in a large space such as a factory or a warehouse, illumination may not be appropriately performed after the environment in the space has changed, for example, after the arrangement of equipment has changed. Therefore, even in such a large space, appropriate illumination is achievable by using the illumination device according to the present invention. For example, in a factory, it is possible to set illumination patterns respectively appropriate for a location where a person works and a location where a robot works. For a location shared by both a person and a robot, it is possible to set an illumination pattern appropriate for both the person and the robot. Moreover, with regard to the detection camera, it is possible to use a camera that has already been disposed, such as a monitor camera, and it is also possible to use a device other than cameras, for example, a sensor that has already been disposed. Alternatively, it is also possible to use a camera of a smartphone, or the like. In this case, more accurate state information can be acquired by registering in advance a desk number of a desk or the like on which the smartphone is disposed as positional information. Alternatively, it is also possible to use a positional information detecting function of a smartphone.

7-1-2

The illumination device of the present invention can also be used as an illumination device for merchandise display. That is to say, it is possible to set an optimal illumination pattern for each piece of merchandise, serving as an illumination target.

7-1-3

The illumination device of the present invention is applicable to a liquid crystal display backlight. Thus, it is possible to allow the neural network to learn to achieve a desirable appearance of an image displayed on a liquid crystal screen, the image serving as an illumination target. In addition, a notification device or the like of a display board or the like can be set so that the illumination pattern is optimized for each viewing position. In this case, the illumination target is a screen such as a liquid display screen, and information on the viewing position from which the screen is viewed constitutes the state data.

7-1-4

In order to avoid a contact between a robot and a person or an object, it is possible to provide light sources such as LEDs on various portions of the robot and set illumination patterns for predetermined motions, the illumination patterns making the respective motions easily visible. In this case, the illumination target is each of the irradiation areas of the light sources that make the predetermined motions of the robot easily visible when the robot performs the respective motions, and the state data is data on the motions of the robot.

7-1-5

It is possible to provide an operating switch with the illumination unit and set illumination patterns so that the brightness of the light source of that illumination unit is adjusted to be appropriate for the ambient brightness.

7-1-6

Headlights and other lights of an automobile are disposed so as to light the road ahead, but, for example, when the automobile goes around a curve, if the direction of the headlights can be changed to a direction in which the automobile goes around the curve, higher visibility can be secured. In view of this, an example in which the illumination device according to the present invention is applied to a headlight of an automobile will be described below.

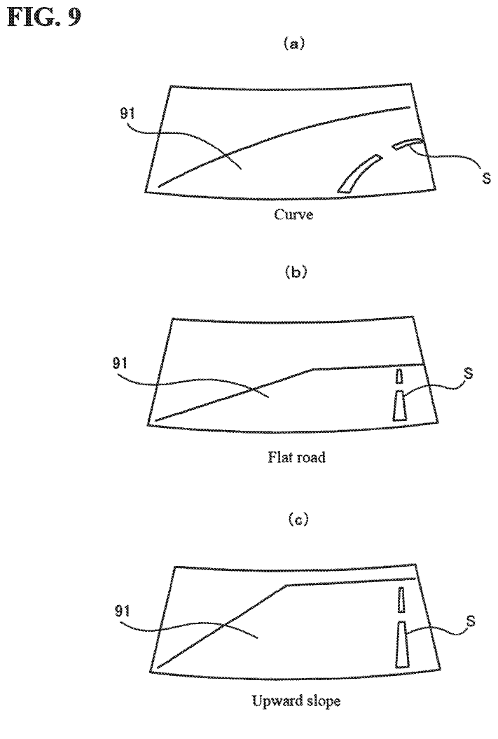

In this example, various kinds of state data can be employed. For example, the steering angle can be used as state data. Also, as shown in FIG. 9(a), it is possible to capture an image of a road 91 in the direction of movement of the automobile using an onboard camera, extract the direction of a center line S, for example, and use the extracted direction as state data. That is to say, state data can be acquired using a variety of sensors and an onboard camera instead of the detection camera 33 of the foregoing embodiment. It should be noted that features of the shape of the road other than the center line can also be extracted as state data. Moreover, in order to perform three-dimensional analysis of the image of the road, a stereo camera, for example, can be employed as the onboard camera.

Then, the direction (illumination pattern) of the headlight at the time when the steering angle and the direction of the road corresponding to each piece of state data are set is optimized. In this manner, each piece of state data and a corresponding optimal illumination pattern are stored as learning data, and the neural network of the arithmetic unit 362 is thus allowed to learn. With such learning data, while driving the automobile, it is possible to obtain an optimal illumination pattern by acquiring state data and adjusting as appropriate the direction of the headlight to an illumination pattern corresponding to the acquired state data. It should be noted that when other factors such as the vehicle speed are included as state data, a more accurate illumination pattern can be obtained. Moreover, learning can also be performed on a road that is reproduced on a model scale, without using a real vehicle.

The direction of the headlight can be optimized for the direction of the road by allowing the neural network to learn in this manner. That is to say, state data is acquired during driving, and based on the acquired state data, illumination pattern data is calculated using the neural network after learning. Then, when this illumination pattern data is sent to a controller that controls the direction of the headlight, the headlight emits light with an optimal illumination pattern for the direction of the road. Thus, irrespective of the direction of the road, a field of view appropriate for the direction of the road can be secured. Moreover, not only the direction of the headlight but also the brightness and the irradiation range can be adjusted. That is to say, even when the automobile goes around a curve, adjustment can be performed so that the headlight can uniformly light the entire road ahead of the automobile.

It should be noted that although the direction of the headlight corresponding to a curve has been described in the example above, for example, as shown in FIGS. 9(b) and 9(c), the present invention is also applicable to a case where the direction of the road changes in the vertical direction like a flat road, a slope, and so on. In this case, state data, which is the direction of the road, can be acquired mainly based on the onboard camera.

Moreover, in addition to roads, the illumination target can also include a vehicle ahead, an oncoming vehicle, a pedestrian, and the like, and it is also possible to set an optimal illumination pattern for such a plurality of illumination targets.

7-2

In the foregoing embodiment, an illumination pattern is created by adjusting whether or not to turn on the LEDs 311 and the brightness and the color of the LEDs 311; however, the present invention is not limited to this, and various illumination patterns associated with illumination, such as the positions of the LEDs 311, can be formed. For example, a plurality of LEDs can be individually moved forward/backward (advanced/retracted), or the angles of a plurality of LEDs can be changed individually. Moreover, it is also possible to create an illumination pattern by providing an optical system such as a lens on the LEDs 311 or in front of the LEDs 311 and adjusting this optical system. For example, a microlens array, a diffuser, or the like can be employed as the optical system. Moreover, a plurality of illumination units 31 individually including LEDs 311 can be provided and illuminate the illumination target from a plurality of positions.

7-3

It is also possible to irradiate a plurality of illumination targets with light using a plurality of light sources. In this case, when a nearby illumination target is irradiated with strong light, strong reflection occurs, whereas when a remote illumination target is irradiated with weak light, weak reflected light occurs. Therefore, an illumination pattern that achieves an optimal light intensity depending on the distance to an illumination target needs to be generated. Even for such a complex illumination target, it is possible to set an optimal illumination pattern by using the neural network.

7-4

An optimal illumination pattern is not limited to an illumination pattern that achieves illumination that can create a contrast as described above. For example, an illumination pattern that makes a specific portion, which serves as an illumination target, more noticeable than the other portions can also be used.

7-5

In the foregoing embodiment, the LEDs 311 are used as light sources. However, the number and the arrangement of LEDs are not limited. The LEDs can also be arranged in a shape other than rectangles. For example, the LEDs can be arranged in a straight line. Moreover, the LEDs can be arranged not only in a plane, but can also be arranged three-dimensionally.

Moreover, the light source is not limited to the LEDs 311, and there is no limitation on the light source as long as the light source can illuminate the illumination target. For example, the light source can be changed depending on the illumination target. Therefore, various types of light sources such as an infrared-emitting diode, a laser diode, a fluorescent lamp, and an incandescent lamp can be used. Moreover, it is also possible to prepare a neural network for each type of light source.

7-6

In order to acquire the state data, various types of detectors such as cameras and a variety of sensors can be used as described above. Alternatively, a configuration is also possible in which the illumination device is not provided with such a detector, and state data acquired by another device is input from an input unit of the illumination device.

7-7

In the foregoing embodiment, the learning unit 363 is provided in the illumination device 3 and is allowed to learn. However, the learning unit 363 is not necessarily required, and it is sufficient if the illumination device contains a neural network after learning (i.e. trained by a learning process). Therefore, a configuration may also be adopted in which learning of the neural network is performed outside the illumination device 3, and the learning result data 354 related to the neural network after learning is stored in the storage unit 32.

Therefore, the learning result data can also be distributed from a maker of the illumination device, or can be delivered over a network and automatically updated. In this case, the PLC needs to be equipped with a communication module (communication unit) so that it can be connected to a network such as the Internet. It should be noted that with regard to the above-described example of an automobile, a configuration is conceivable in which the learning data and the learning result data are prepared by a carmaker and updated by a dealer of the carmaker.

7-8

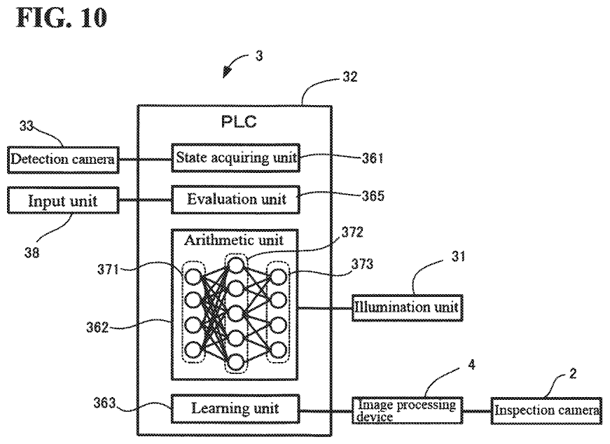

In each of the foregoing examples, an optimal illumination pattern is set in advance. However, an optimal illumination pattern may also be set in accordance with an instruction from the user. For example, a PLC such as that shown in FIG. 10 may be used. A functional configuration of this PLC includes the configuration of the PLC shown in FIG. 3 and also includes an evaluation unit 365. The evaluation unit 365 is configured to function in response to an input from an input unit 38 for accepting an instruction from the user. The input unit 38 may be composed of various input devices, such as a touch panel, a keyboard, and operating buttons. The instruction input to the input unit 38 includes a target value, and an example thereof is an instruction to “irradiate an illumination target surface uniformly (e.g., within a tolerance of 3%)”. When such an instruction is input from the input unit 38, the state acquiring unit 361 computes the uniformity of the current illumination target surface, that is, the tolerance, from an image obtained by the detection camera 33. Next, the evaluation unit 365 compares the tolerance 3% (target value), which is instructed by the user, with the tolerance (variation) computed by the state acquiring unit 361. That is to say, the evaluation unit 365 calculates the difference between the tolerance instructed by the user and an actual distribution of illumination on the illumination target surface. Then, the arithmetic unit 362 performs learning so as to reduce the difference to zero, while successively outputting sets of illumination pattern data from the output layer 373. The sets of illumination pattern data are output to the illumination unit 31, and the illumination unit 31 performs illumination in accordance with the acquired sets of illumination pattern data.

Moreover, if a change occurs in the illumination target surface, for example, if the shape of the illumination target surface changes, or another object appears on the illumination target surface, a change occurs in the distribution of illumination computed by the state acquiring unit 361 as well. Therefore, the evaluation unit 365 compares the input tolerance (or a preset target value) with the changed actual distribution of illumination in the same manner as described above. Then, the arithmetic unit 362 performs learning so as to reduce the difference to zero, meanwhile outputting sets of illumination pattern data from the output layer 373.

The evaluation unit 365 performs calculation of the above-described difference until the difference becomes zero or until the difference becomes lower than a predetermined value. Based on this, the arithmetic unit 362 continues learning. Then, when the above-described difference becomes zero, or when the above-described difference becomes lower than the predetermined value, the arithmetic unit 362 completes learning, and the illumination unit 31 maintains the illumination state with the illumination pattern at that point in time. Such learning can be performed not by an NN (neural network) but also by a reinforcement learning, for example.

It should be noted that the target value and the current value are not limited to numerical values such as illuminance, and may also be image information or the like. Moreover, when learning is completed, and the illumination state reaches the target value, the PLC may notify the user of the attainment of the goal. Furthermore, the PLC may be configured to accept an additional request, such as a request to partially change brightness or a request to partially change color, through the input unit 38.

The above-described learning control can be used for not only the PLC shown in FIG. 10 but also for various types of illumination described in the modifications.

7-9

In the foregoing embodiment, an example of the neural network has been described. However, the present invention is not limited to this example, and various forms of neural networks, including those having various numbers of layers, can be used. For example, a recursive neural network, a convolutional neural network, and the like can be used.

(Additional Remark 1)

An illumination device including:
at least one light source configured to perform illumination with a plurality of illumination patterns;
a detection unit for detecting state information on the state of an illumination target that is to be illuminated by the light source; and
at least one hardware processor,
wherein the hardware processor calculates, using a neural network, illumination pattern information for generating an illumination pattern appropriate for the illumination target from the state information, and
the light source is controlled in order to perform illumination with an illumination pattern based on the illumination pattern information.

(Additional Remark 2)

An illumination method including:
a step of detecting state information on the state of an illumination target that is to be illuminated by a light source;
a step of at least one hardware processor calculating, using a neural network, illumination pattern information for generating an illumination pattern of the light source appropriate for the illumination target from the state information; and
a step of at least one hardware processor controlling the illumination pattern of the light source based on the illumination pattern information.

### REFERENCE SIGNS LIST

3 . . . illumination device
311 . . . LED (light source)
312 . . . controller (illumination control unit)
33 . . . detection camera (detection unit)
362 . . . arithmetic unit
363 . . . learning unit

1. An illumination device comprising:
at least one light source that performs illumination with a plurality of illumination patterns; and
a processor configured with a program to perform operations comprising:
operation as a detection unit that detects state information on a state of an illumination target that is to be illuminated by the light source (311);
operation as an arithmetic unit configured to calculate, using a neural network, illumination pattern information for generating an illumination pattern appropriate for the illumination target from the state information; and
operation as an illumination control unit configured to control the light source in order to perform illumination with an illumination pattern based on the illumination pattern information.

2. The illumination device according to claim 1, wherein the processor is configured with the program such that operation as the detection unit comprises operation as the detection unit configured to acquire an image of the illumination target and calculate the state information from the image.

3. The illumination device according to claim 1, wherein the processor is configured with the program such that operation as the arithmetic unit comprises operation as the arithmetic unit that comprises a neural network for each of a plurality of illumination targets or for each of a plurality of types of light sources.

4. The illumination device according to claim 1, wherein the illumination pattern comprises at least one of brightness, color, direction, position, and whether light is emitted from the at least one light source.

5. The illumination device according to claim 1, wherein the processor is configured with the program to perform operations further comprising operation as a communication unit for receiving that receives learning data for training the neural network over a network.

6. The illumination device according to claim 1, wherein the processor is configured with the program to perform operations further comprising operation as a learning unit for training that trains the neural network using learning data, the learning data comprising the state information detected by the detection unit and illumination pattern data corresponding to the state information.

7. An illumination method comprising:
detecting state information on a state of an illumination target that is to be illuminated by a light source;
calculating, using a neural network, illumination pattern information for generating an illumination pattern of the light source appropriate for the illumination target from the state information; and
controlling the illumination pattern of the light source based on the illumination pattern information.

8. The illumination method according to claim 7, further comprising:
obtaining learning data, the learning data comprising the state information and illumination pattern data for performing optimal illumination corresponding to the state information; and
training the neural network using the learning data.

9. A non-transitory computer-readable storage medium storing an illumination program, which when read and executed, causes a computer to perform operations comprising:
detecting state information on a state of an illumination target that is to be illuminated by a light source;
calculating, using a neural network, illumination pattern information for generating an illumination pattern of the light source appropriate for the illumination target from the state information; and
controlling the illumination pattern of the light source based on the illumination pattern information.

10. The non-transitory computer-readable storage medium according to claim 9, wherein the illumination program, when read and executed, causes the computer to perform operations further comprising:
obtaining learning data, the learning data comprising the state information and illumination pattern data for performing optimal illumination corresponding to the state information; and
training the neural network using the learning data.

11. The illumination device according to claim 2, wherein the processor is configured with the program such that operation as the arithmetic unit comprises operation as the arithmetic unit that comprises a neural network for each of a plurality of illumination targets or for each of a plurality of types of light sources.

12. The illumination device according to claim 2, wherein the illumination pattern comprises at least one of brightness, color, direction, position, and whether light is emitted from the at least one light source.

13. The illumination device according to claim 2, wherein the processor is configured with the program to perform operations further comprising operation as a communication unit for receiving learning data for training the neural network over a network.

14. The illumination device according to claim 2, wherein the processor is configured with the program to perform operations further comprising operation as a learning unit for training the neural network using learning data, the learning data comprising the state information detected by the detection unit and illumination pattern data corresponding to the state information.

15. The illumination device according to claim 3, wherein the illumination pattern comprises at least one of brightness, color, direction, position, and whether light is emitted from the at least one light source.

16. The illumination device according to claim 3, wherein the processor is configured with the program to perform operations further comprising operation as a communication unit for receiving learning data for training the neural network over a network.

17. The illumination device according to claim 3, wherein the processor is configured with the program to perform operations further comprising:
operation as a learning unit for training the neural network using learning data, the learning data comprising the state information detected by the detection unit and illumination pattern data corresponding to the state information.

18. The illumination device according to claim 4, wherein the processor is configured with the program to perform operations further comprising operation as a communication unit for receiving learning data for training the neural network over a network.

19. The illumination device according to claim 4, wherein the processor is configured with the program to perform operations further comprising operation as a learning unit for training the neural network using learning data, the learning data containing the state information detected by the detection unit and illumination pattern data corresponding to the state information.
